(19) United States
(12) Patent Application Publication
(10) Pub. No.: US 2006/0091939 A1
(43) Pub. Date: May 4, 2006

(54) Power supply circuit of delay locked loop

(75) Inventors: Chang-Ho Do, Ichon-shi (KR); Dong-Keun Kim, Ichon-shi (KR)

Correspondence Address: MCDERMOTT WILL & EMERY LLP, 600 13TH STREET, N.W., WASHINGTON, DC, 20005-3096, US

(73) Assignee: Hynix Semiconductor Inc., Inchon-shi (KR)

(21) Appl. No.: 11/020,307

(22) Filed: Dec. 27, 2004

(30) Foreign Application Priority Data
Oct. 30, 2004 (KR) 10-2004-0087698

(51) Int. Cl. G05F 1/10

(52) U.S. Cl. 327/543

(57) ABSTRACT

A driving voltage is supplied to a delay locked loop, with having the same voltage level as the power supply voltage but reduced variation and, accordingly, the delay locked loop can be operated more stably. Further, the two different levels of the driving voltage may be provided to the delay locked loop so that various test modes can be provided. The power supply circuit of a delay locked loop includes a voltage comparing unit for comparing the driving voltage with a reference voltage and disabled in response to a selection signal, a driving unit for supplying charges transferred from the power supply voltage into an output terminal so as to increase a voltage level of the driving voltage, in response to the comparison result of the voltage comparing unit; and a control unit for supplying the charges from the driving unit into the output terminal in response to the selection signal, to control the driving voltage to be substantially equal to the power supply voltage.

### FIELD OF INVENTION

The present invention relates to a semiconductor integrated circuit; and, more particularly, to a power supply circuit of a delay locked loop in a semiconductor memory device.

### DESCRIPTION OF PRIOR ART

A semiconductor memory device has been continuously improved to increase its operational speed with increased integration. There has been introduced, so called, a synchronous memory device which operates in synchronization with an external clock signal, so as to improve the operational speed of the semiconductor memory device.

The initially introduced one is an SDR(Single Data Rate) synchronous semiconductor memory device performs one data input/output operation in one period of the external clock in synchronization with the rising edge of the external clock signal of the memory device.

However, the SDR synchronous semiconductor memory device had to be more improved for use in a high-speed system. Therefore, a DDR (Double Data Rate) synchronous semiconductor memory device has been developed, which processes data twice within one period of the external clock signal.

Since the DDR synchronous semiconductor memory device performs the data output operations at both of the rising edge and the falling edge of the external clock signal, the operational margin for the data input/output in synchronization with the external clock is significantly insufficient.

The DDR synchronous memory device can perform normal operation only when data input/output timing exactly coincides with the rising and falling edges of the external clock. However, there is inevitable delay that occurs in use of the external clock within the memory device.

Basically, the delay occurs in a clock input buffer that receives and buffers the external clock to output an internal clock and in an output buffer for outputting data in synchronization with the internal clock.

Due to such a delay, the output timing at which data is actually outputted from the memory device does not coincide with the rising and falling edges of the external clock.

The output data is outputted with a significant delay compared with the external clock and, accordingly, output data access time tAC that is the time from the external clock input to the data output can be long.

To resolve such a problem, the memory device supplies a delay locked clock signal that leads in its phase by a predetermined time, compared with the internal clock, and outputs data in synchronization with the delay locked clock signal.

As such, the DDR synchronous memory device includes a circuit for outputting the delay locked clock, so called a delay locked loop circuit.

The delay locked loop models the delay time of the external clock, which occurs due to the clock input buffer and the data output buffer, to achieve a delay locked time and output the delay locked clock having a leading timing as the achieved time.

The output data that is outputted out of the memory device in synchronization with the delay locked clock exactly coincides with the external clock.

Accordingly, the delay locked loop is an important circuit for determining the data output timing in the synchronous memory device. Further, in the trend of pursuing higher speed of data output, the delay locked loop becomes more important.

Particularly, since the signal phase from the delay locked loop can be affected even with minute internal operation variation, it is important to supply the delay locked loop with a stable power supply voltage.

Therefore, the semiconductor memory device typically includes a separate power supply circuit for the delay locked loop to supply the power for the delay locked loop so that performance deterioration can be prevented even with temporal variation of a level of an external power voltage.

FIG. 1 is a block diagram showing a conventional power supply circuit of a delay locked loop.

Referring to FIG. 1, the conventional power supply circuit of the delay locked loop receives a power supply voltage VDD and a ground voltage VSS to provide the delay locked loop 20 with a driving voltage VDLL of the delay locked loop 20.

FIG. 2 is a block diagram showing the delay locked loop in FIG. 1.

Referring to FIG. 2, the delay locked loop includes a clock buffer 21 for buffering an external clock CLK to output an internal clock CLKin, a variable delay line 22 for delaying the internal clock CLKin to output a delay locked output clock dllCLK, a phase comparer 23 for comparing the internal clock CLKin as a reference signal REF with the feedback output CLKfb, a controlling unit 24 for controlling the delay of the variable delay line 22 depending on the comparison signal from the phase comparer 23, and a delay model 25 for delaying the delay locked output clock dllCLK by the modeled time to output the feedback clock CLKfb.

It will be described for the operation of the conventional delay locked loop with reference to FIG. 2.

First, the clock buffer 21 buffers the external clock CLK to output the internal clock CLKin. Then, the variable delay line 22 delays the internal clock CLKin by a predetermined time to output the output clock dllCLK.

Then, the delay model 25 delays the output clock dllCLK by the modeled delay to output the feedback clock CLKfb. Here, the modeled delay is the value that is modeled the delay time of the external clock CLK in the clock buffer 21 and the data output buffer (not shown) of inner circuits in the memory device.

Then, the phase comparer 23 compares the phase of the feedback clock CLKfb with the internal clock CLKin as the reference voltage REF to output the comparison signals PUSH, PULL depending on the comparison result.

Then, the delay line controlling unit 24 adjusts the delay time of the delay line 22 based on the comparison signals PUSH, PULL.

Then, the variable delay line 22 outputs the output clock dllCLK of the internal clock CLKin, that is delayed by the adjusted time, and the delay model 25 delays the output clock dllCLK by the prescribed modeled delay time to output the feedback clock CLKfb to the phase comparer 23.

The above procedure continues until the two clocks CLKin, CLKfb that are inputted to the phase comparer 23 coincide with each other. When the two clocks CLKin, CLKfb that are inputted to the phase comparer 23 coincide with each other, the delay line controlling unit 24 does not change the delay time any more.

From then, the internal clock CLKin is delayed by the fixed delay in the variable delay line 22 to output the output clock dllCLK. The output clock dllCLK is the delay locked clock.

With using the delay locked clock to output data, the data output timing at which the memory device outputs data can exactly coincide with the rising and falling edges of the external clock CLK.

FIG. 3 is a detailed block diagram showing a power supply circuit of a delay locked loop shown in FIG. 1.

Referring to FIG. 3, the power supply circuit of the delay locked loop includes a comparing unit 11 for comparing a driving voltage VDLL for the delay locked loop with a reference voltage VR, and a driver 12 for supplying the driving voltage VDLL depending on the comparison result of the comparing unit 11.

The comparing unit 11 includes NMOS transistors MN2, MN3 having gates receiving the reference voltage VR and the driving voltage VDLL, respectively, an NMOS transistor MN4 having a gate receiving the reference voltage VR, one end coupled to one end of the NMOS transistor MN2 and one end of the NMOS transistor MN3, and the other end coupled to a ground voltage VSS, a PMOS transistor MP3 having a gate diode-coupled to the other end of the NMOS transistor MN3 for connecting the other end of the NMOS transistor MN3 to the power supply voltage VDD, and a PMOS transistor MP2 for connecting the other end of the NMOS transistor MN2 to the power supply voltage VDD and forming a current mirror with the PMOS transistor MP3 to output a comparison signal dr at the common node of the PMOS transistor MP2 and the NMOS transistor MN2.

The driver 12 includes a PMOS transistor MP1 having one end receiving the power supply voltage and the other end for supplying the driving voltage VDLL of the delay locked loop depending on the comparison signal dr.

It will be described for the operation of the power supply circuit of the delay locked loop with reference to FIG. 3.

The power supply circuit of the delay locked loop outputs the driving voltage VDLL having a constant level. Upon operating the delay locked loop, the level of the driving level decreases.

At this point, the comparing unit 11 compares the level of the driving voltage VDLL with the reference voltage VR having a constant level to activate the comparison signal dr to low when the driving voltage VDLL is lower than the reference voltage VR.

In response to activation of the comparison signal dr to the low level, the driving MOS transistor MP1 in the driver 12 is turned on so that the power supply voltage is supplied from one end to the other end to increase the voltage level of the driving voltage VDLL.

When the driving voltage VDLL reaches the reference voltage VR, the comparison signal dr is deactivated to high.

If the voltage level of the driving voltage VDLL again becomes lower than the reference voltage VR as the delay locked loop operates, the driving voltage VDLL is increased by performing the procedure as prescribed above.

At this point, the reference voltage VR is maintained in the voltage level that is required to operate the delay locked loop, typically in a lower level than an external power supply voltage.

Because of the separate power supply circuit for supplying the driving voltage to the delay locked loop, the delay locked loop can be operated stably even with voltage level variation of the external power supply voltage VDD.

However, in a particular event of the memory device (e.g., an event in which the memory device escapes power down mode), the variation of the driving voltage VDLL can be greater than the variation of the external power supply voltage VDD. In such a case, the delay locked loop using the driving voltage VDLL can go through deterioration of operational characteristic compared with using directly the external power supply voltage VDD.

Further, since the driving voltage VDLL has its level lower than the external power supply voltage VDD, the operational time of the delay locked loop can be increased, particularly, the delay time of the unit delay in the variable delay line, and, accordingly, jitter component of the delay locked loop can be increased.

### SUMMARY OF INVENTION

It is, therefore, an object of the present invention to provide a power supply circuit of a delay locked loop (DLL), capable of supplying the DLL with a stable driving voltage without regard to variation of external power supply voltage.

Further, it is another object of the present invention to provide a power supply circuit of a DLL, capable of generating a driving voltage having a level equal to an external power supply voltage.

In accordance with an aspect of the present invention, there is provided a semiconductor memory device incorporating therein a circuitry capable of stably supplying a driving voltage, including: a power supplier for supplying a driving voltage in response to an activation state of a selection signal; and a delay locked loop (DLL) for synchronizing an internal clock signal with an external clock signal.

In accordance with another aspect of the present invention, there is provided a power supply circuit of a DLL, including a voltage comparator for comparing the driving voltage with a reference voltage, the voltage comparator being disabled in response to a selection signal; a driving unit for supplying charges transferred from the power supply voltage into an output terminal so as to increase a voltage level of the driving voltage, in response to the comparison result of the voltage comparator; and a controller for supplying the charges from the driving unit into the output terminal in response to the selection signal, to control the driving voltage to be substantially equal to the power supply voltage.

### BRIEF DESCRIPTION OF THE DRAWINGS

The above and other objects and features of the present invention will become apparent from the following description of preferred embodiments taken in conjunction with the accompanying drawings, in which:

FIG. 1 is a block diagram showing a conventional power supply circuit of a delay locked loop;

FIG. 2 is a block diagram showing a delay locked loop in FIG. 1;

FIG. 3 is a detailed block diagram showing a power supply circuit of a delay locked loop shown in FIG. 1;

FIG. 4 is a block diagram showing a power supply circuit of a delay locked loop in accordance with a preferred embodiment of the present invention;

FIG. 5 is a circuit diagram showing in detail a power supply circuit of a delay locked loop shown in FIG. 4; and

FIG. 6 is a block diagram showing a power supply circuit of a delay locked loop in accordance with another preferred embodiment of the present invention.

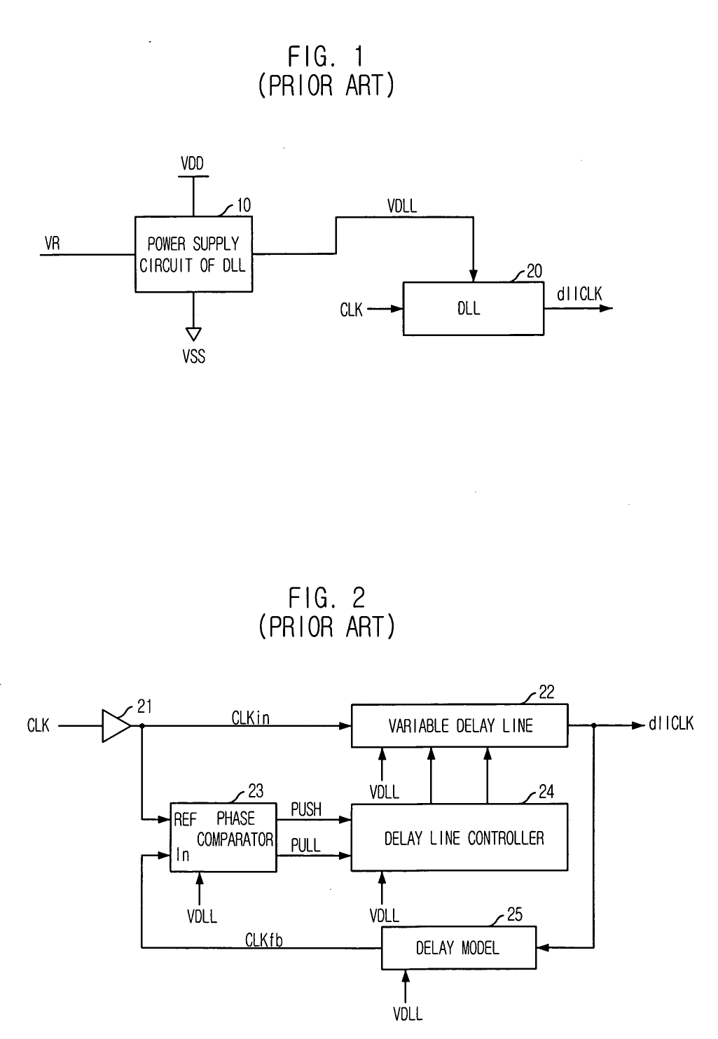

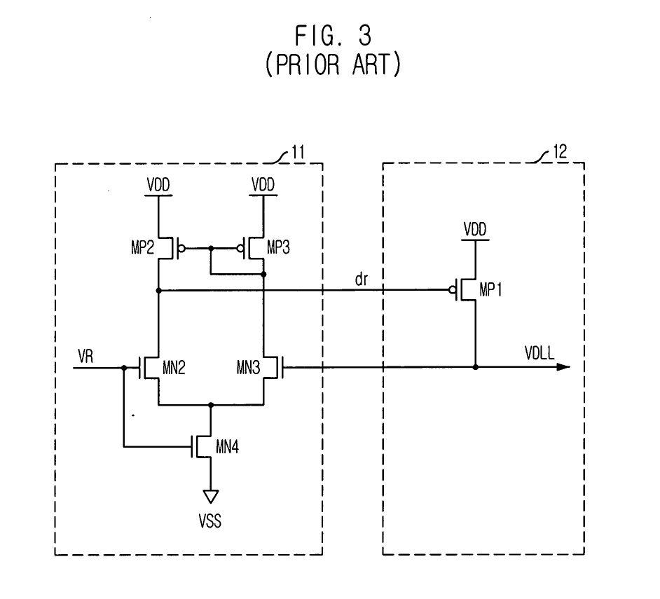

### DETAILED DESCRIPTION OF INVENTION

Hereinafter, a power supply circuit of a delay locked loop (DLL) in accordance with the present invention will be described in detail referring to the accompanying drawings.

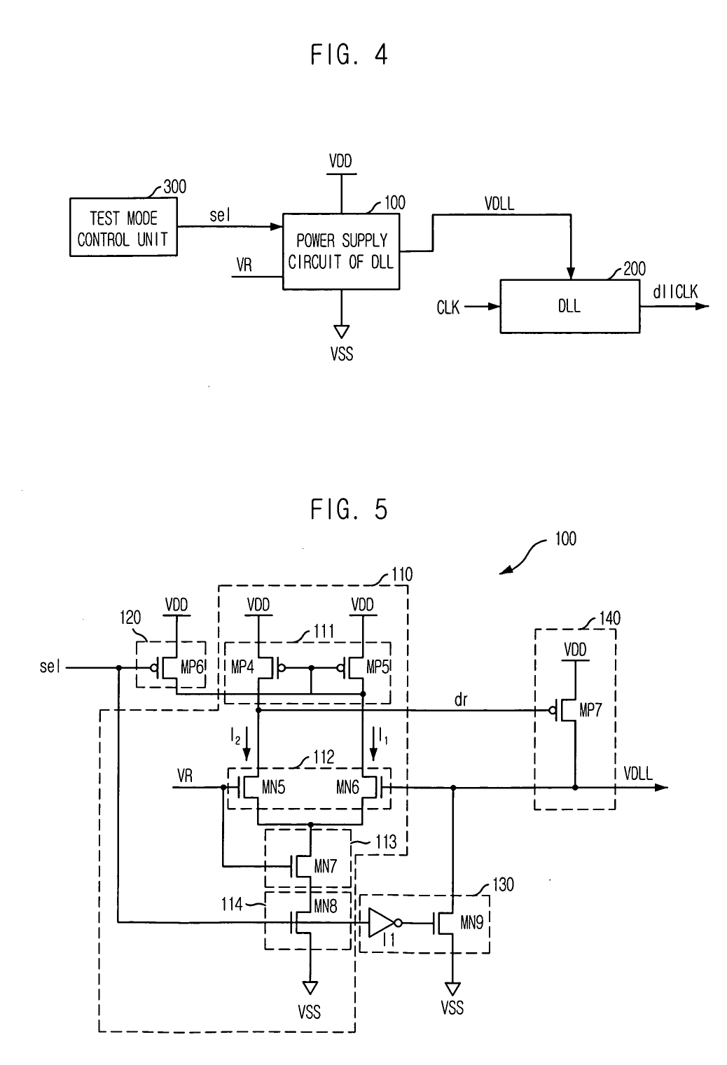

FIG. 4 is a block diagram showing a power supply circuit of a delay locked loop in accordance with a preferred embodiment of the present invention.

Referring to FIG. 4, the power supply circuit of a delay locked loop outputs a driving voltage VDLL having a level that is equal to a power supply voltage to the delay locked loop 200 when a selection signal sel that is outputted from a test mode controlling unit 300 is activated, and outputs the driving voltage VDLL having a level that is equal to a reference voltage VR to the delay locked loop 200 when a selection signal sel is deactivated. The delay locked loop 200 is used for synchronizing an internal clock with an external clock.

FIG. 5 is a circuit diagram showing in detail a power supply circuit of a delay locked loop shown in FIG. 4.

Referring to FIG. 5, the power supply circuit of the delay locked loop includes a voltage comparing unit 110 for comparing the level of the driving voltage VDLL with the reference voltage VR and disabled in response to the selection signal sel, a driving unit 140 for supplying an output with charge from the power supply voltage VDD to increase the level of the driving voltage VDLL in response to the comparison result of the voltage comparing unit 110, and a controlling unit 130 for supplying the output with charge from the driving unit 140 to make the driving voltage VDLL substantially equal to the power supply voltage VDD.

The voltage comparing unit 110 includes a differential amplifying circuit for comparing the driving voltage VDLL with the reference voltage VR, which includes a current mirror 111 for providing a first current I₁ and a second current I₂, the second current I₂ being generated by mirroring the first current I₁, a differential inputting unit 112 for adjusting the current amount of the first current I₁ and the second current I₂ depending on the level of the driving voltage VDLL and the reference voltage VR, a constant current source 113 for discharging, depending on the reference voltage VR, the first current I₁ and the second current I₂ that pass through the differential inputting unit 112, and a switch 114 for allowing or blocking discharge of the constant current source 113 in response to the selection signal sel.

The power supply circuit of the delay locked loop of the present embodiment further includes a disabling unit 120 for disabling the current mirror 111 in response to the selection signal sel.

The disabling unit 120 includes a PMOS transistor MP6 having one end coupled to the power supply voltage VDD for providing the power supply voltage VDD to a common gate stage of PMOS transistors MP4, MP5 in the current mirror 111, in response to the selection signal sel.

The current mirror 111 includes the PMOS transistor MP5 having one end coupled to the power supply voltage VDD, and a gate coupled to the other end for flowing the first current I₁ through the other end, and the PMOS transistor MP4 having one end coupled to the power supply voltage VDD, a gate coupled to the gate of the PMOS transistor MP5, and the other end for flowing the second current I₂ for which the first current I₁ is mirrored.

The differential inputting unit 112 includes an NMOS transistor MN6 for adjusting the amount of the first current I₁ provided through one end to provide the adjusted current to the other end, in response to the driving voltage VDLL that is inputted to a gate of the NMOS transistor MN6, and an NMOS transistor MN5 for adjusting the amount of the second current I₂ provided through one end to provide the adjusted current to the other end, in response to the reference voltage VR that is inputted to a gate of the NMOS transistor MN5.

The constant current source 113 includes an NMOS transistor MN7 having a gate receiving the reference voltage VR and one end receiving the first current I₁ and the second current I₂ to provide to the other end.

The switch 114 includes an NMOS transistor MN8 having a gate receiving the selection signal sel for connecting or disconnecting the other end of the NMOS transistor MN7 to or from a ground voltage VSS.

The driving unit includes a driving PMOS transistor MP7 having one end receiving the power supply voltage VDD, the other end coupled to the output, and a gate receiving the comparison signal dr from the voltage comparing unit 110.

The controlling unit 130 includes an inverter I1 for inverting the selection signal sel, and a controlling NMOS transistor MN9 having a gate receiving the output of the inverter I1, one end coupled to the gate of the driving PMOS transistor MP7, and the other end coupled to the ground voltage VSS.

It will be described for the operation of the power supply circuit of the delay locked loop of the embodiment with reference to FIGS. 4 and 5.

The test mode controlling unit 500 decodes a combination of externally inputted signals to provide the selection signal that is activated to low when having a particular combination.

First, consider a case in which the selection signal sel is deactivated to high and, accordingly, the disabling unit 120 and the controlling unit 130 are deactivated while the comparing unit 110 maintains activated state.

At this point, the switch NMOS transistor MN8 of the comparing unit 110 is turned on so as to flow the first current I₁ and the second current I₂ that are summed through the NMOS transistor MN7 to the ground voltage VSS.

The comparing unit 110 compares the driving voltage VDLL with the reference voltage VR of a constant level to activate the comparison signal dr to low when the driving voltage VDLL is lower than the reference voltage VR.

The driving MOS transistor MP7 of the driver 140 is turned on by the comparison signal dr that is activated to low so as to supply the output with charge from one end coupled the power supply voltage VDD and, accordingly, increase the voltage level of the driving voltage VDLL.

When the level of the driving voltage VDLL is equal to the reference voltage VR, the comparison signal dr is deactivated to high.

If the voltage level of the driving voltage VDLL again becomes lower than the reference voltage VR as the delay locked loop operates, the driving voltage VDLL is increased by performing the procedure as prescribed above.

Next, consider a case in which the selection signal sel is activated to low and, accordingly, the disabling unit 120 and the controlling unit 130 are activated while the comparing unit 110 maintains deactivated state.

Particularly, the MOS transistor MP6 of the disabling unit 120 is turned on to supply the current mirror 111 with the power supply voltage VDD, which makes the two PMOS transistors MP4, MP5 of the current mirror 111 in the comparing unit 110 maintain turned-off state.

Further, the switching MOS transistor MN8 is turned off so that current does not flow to the ground voltage through the MOS transistor MN7 that acts as the constant current source.

Accordingly, the output stage from which the comparison signal dr from the comparing unit 110 outputs becomes floating state.

On the other hand, the NMOS transistor MN9 of the controlling unit 130 is turned on and, accordingly, the PMOS transistor MP7 of the driver 140 is turned on so as to output the driving voltage VDLL having the same level as the power supply voltage VDD.

In this case, the level of the driving voltage VDLL is forced to increase to the level of the power supply voltage VDD.

Accordingly, when the selection signal sel is inputted in deactivated to high, the level of the driving voltage VDLL outputs as same as the level of the reference voltage VR. When the selection signal sel is activated to low, the level of the driving voltage VDLL outputs as same as the level of the power supply voltage VDD. That is, the delay locked loop may be driven with two voltage levels.

At this point, when the delay locked loop is driven with the driving voltage VDLL having the same level as the power supply voltage, the driving voltage VDLL that is supplied to the delay locked loop is outputted through the turn-on resistor of the PMOS transistor MP7 to have the same level as the power supply voltage but reduced variation even when there is variation in the power supply voltage due to noise.

Therefore, the delay locked loop may perform more stable delay lock operation.

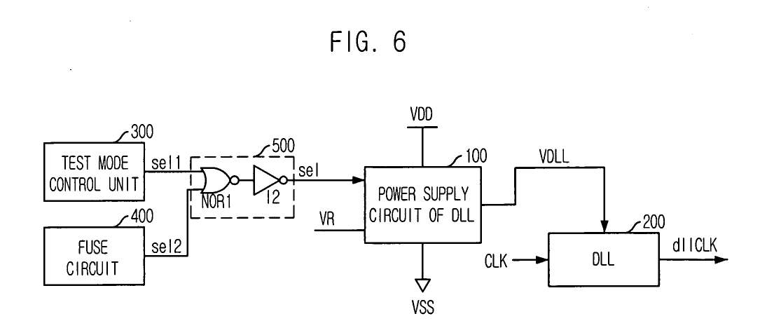

FIG. 6 is a block diagram showing a power supply circuit of a delay locked loop in accordance with another preferred embodiment of the present invention.

Referring to FIG. 6, the power supply circuit further includes a test controlling unit 300 for decoding a combination of externally inputted signals to provide the selection signal sel when having a particular combination, a fuse circuit 400 having a fuse for outputting the selection signal sel with a fixed level depending on blowing of the fuse, and a logic circuit 500 for transferring the selection signal sell from the test mode controlling unit 300 or the selection signal sel2 from the fuse circuit 400.

The logic circuit 500 includes a NOR gate NOR1 receiving the selection signal sell from the test mode controlling unit 300 or the selection signal sel2 from the fuse circuit 400, and an inverter I2 for inverting the output of the NOR gate NOR1.

As shown in FIG. 6, the fuse circuit 400 outputs the selection signal sel2 having the fixed level depending on blowing of the fuse.

In the test mode, it is determined if the delay locked loop optimally operates with the driving voltage VDLL that is equal to the reference voltage or with the driving voltage VDLL that is equal to the power supply voltage. At this point, the selection signal sell is transferred to the power supply circuit of the delay locked loop through the logic circuit 500.

After the test, the state of the outputted selection signal sel is fixed depending on the blowing of the fuse of the fuse circuit 400. Then, when the memory device operates, the selection signal sel2 is transferred to the power supply circuit 100 of the delay locked loop through the logic circuit 500.

In the present invention, regardless of variation in the external power supply voltage, the driving voltage is supplied with having the same voltage level as the power supply voltage but reduced variation. Accordingly, the delay locked loop can be operated more stably.

Further, in the present invention, the two different levels for the driving voltage may be provided to the delay locked loop so that various test modes can be provided.

The present application contains subject matter related to the Korean patent application No. KR 2004-97698, filled in the Korean Patent Office on Oct. 30, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A semiconductor memory device incorporating therein a circuitry capable of stably supplying a driving voltage, comprising:
a power supply means for supplying a driving voltage in response to an activation state of a selection signal; and
a delay locked loop (DLL) for synchronizing an internal clock signal with an external clock signal.

2. The semiconductor memory device as recited in claim 1, further comprising a test mode control means for outputting a first selection signal under a test mode.

3. The semiconductor memory device as recited in claim 1, wherein the power supply means supplies a driving voltage with a voltage level corresponding to a power supply voltage while the selection signal is activated, or supplies a driving voltage with a voltage level corresponding to a reference voltage while the selection signal is deactivated.

4. The semiconductor memory device as recited in claim 1, wherein the power supply means includes:
a voltage comparator for comparing the driving voltage with the reference voltage, the voltage comparator being disabled in response to the selection signal;
a driving unit for supplying charges transferred from the power supply voltage into an output terminal so as to increase a voltage level of the driving voltage, in response to the comparison result of the voltage comparator; and
a control unit for supplying the charges from the driving unit into the output terminal in response to the selection signal, to control the driving voltage to be substantially equal to the power supply voltage.

5. The semiconductor memory device as recited in claim 1, further comprising:
a test mode control means for outputting a first selection signal;
a fuse circuit for outputting a second selection signal with a predetermined logic level depending on blowing of a fuse; and
a logic circuit for transferring the first selection signal or the second selection signal through a predetermined logic operation.

6. The semiconductor memory device as recited in claim 5, wherein the logic circuit includes:
a NOR gate for performing a logic NOR operation to the first selection signal and the second selection signal; and
an inverter for inverting the output signal of the NOR gate to output the selection signal.

7. The semiconductor memory device as recited in claim 6, wherein the logic circuit transfers the first selection signal to the power supply means during a test mode and transfers the second selection signal to the power supply means after the test mode.

8. The semiconductor memory device as recited in claim 5, wherein the voltage supply means includes:
a voltage comparator for comparing the driving voltage with the reference voltage, the voltage comparator being disabled in response to the selection signal;
a driving unit for supplying charges transferred from the power supply voltage into an output terminal so as to increase a voltage level of the driving voltage, in response to the comparison result of the voltage comparator; and
a control unit for supplying the charges from the driving unit into the output terminal in response to the selection signal, to control the driving voltage to be substantially equal to the power supply voltage.

9. A power supply circuit of a delay locked loop comprising:
a voltage comparing means for comparing the driving voltage with a reference voltage, the voltage comparing means being disabled in response to a selection signal;
a driving means for supplying charges transferred from the power supply voltage into an output terminal so as to increase a voltage level of the driving voltage, in response to the comparison result of the voltage comparing means; and
a control means for supplying the charges from the driving means into the output terminal in response to the selection signal, to control the driving voltage to be substantially equal to the power supply voltage.

10. The power supply circuit of a delay locked loop as recited in claim 9, wherein the voltage comparing means includes a differential amplifying circuit for comparing the level of the driving voltage with the reference voltage.

11. The power supply circuit of a delay locked loop as recited in claim 9, wherein the voltage comparing means includes:
a current mirroring unit for providing a first current and a second current, the second current being generated by mirroring the first current;
a differential inputting unit for adjusting the current amount of the first current and the second current depending on the levels of the driving voltage and the reference voltage;
a constant current source for discharging, depending on the reference voltage, the first and the second currents that pass through the differential inputting unit; and
a switching unit for allowing or blocking discharge of the constant current source in response to the selection signal.

12. The power supply circuit of a delay locked loop as recited in claim 9, further comprising a disabling means for disabling the current mirroring unit in response to the selection signal.

13. The power supply circuit of a delay locked loop as recited in claim 9, wherein the current mirroring unit includes:
a first PMOS transistor having one end coupled to the power supply voltage, and a gate coupled to the other end for flowing the first current through the other end; and
a second PMOS transistor having one end coupled to the power supply voltage, a gate coupled to the gate of the first PMOS transistor, and the other end for flowing the second current that is generated by mirroring the first current.

14. The power supply circuit of a delay locked loop as recited in claim 12, wherein the disabling means includes a third MOS transistor having one end coupled to the power supply voltage for providing the power supply voltage to the common gate of the first and second PMOS transistors in response to the selection signal.

15. The power supply circuit of a delay locked loop as recited in claim 11, wherein the differential inputting unit includes:
a first NMOS transistor having one end receiving the first current and a gate receiving the driving voltage for adjusting the amount of the first current to provide the adjusted first current to the other end of the first NMOS transistor, in response to the driving voltage; and
a second NMOS transistor having one end receiving the second current and a gate receiving the reference voltage for adjusting the amount of the second current to provide the adjusted second current to the other end of the second NMOS transistor, in response to the reference voltage.

16. The power supply circuit of a delay locked loop as recited in claim 11, wherein the constant current source includes a third NMOS transistor having a gate receiving the reference voltage and one end receiving the first and second currents to provide to the other end of the third NMOS transistor.

17. The power supply circuit of a delay locked loop as recited in claim 11, wherein the switching unit includes a fourth NMOS transistor having a gate receiving the selection signal for connecting or disconnecting the other end of the third NMOS transistor to or from a ground voltage.

18. The power supply circuit of a delay locked loop as recited in claim 11, wherein the driving unit includes a driving PMOS transistor having one end receiving the power supply voltage, the other end coupled to the output, and a gate receiving the comparison signal from the voltage comparing means.

19. The power supply circuit of a delay locked loop as recited in claim 9, wherein the control means includes:
an inverter for inverting the selection signal; and
a controlling NMOS transistor having a gate receiving the output of the inverter, one end coupled to the gate of the driving PMOS transistor, and the other end coupled to the ground voltage.
